(19) United States
(12) Patent Application Publication
(10) Pub. No.: US 2025/0346040 A1
(43) Pub. Date: Nov. 13, 2025

(54) LIQUID STORAGE CONTAINER, METHOD FOR MANUFACTURING LIQUID STORAGE CONTAINER, AND METHOD FOR REUSING LIQUID STORAGE CONTAINER

(71) Applicant: CANON KABUSHIKI KAISHA, Tokyo (JP)

(72) Inventor: SATOSHI IBE, Kanagawa (JP)

(21) Appl. No.: 19/195,952

(22) Filed: May 1, 2025

(30) Foreign Application Priority Data
May 13, 2024 (JP) 2024-077935

(51) Int. Cl. B41J 2/175; B29B 9/10; B29B 9/12; B29B 17/00; B29B 17/02; B29C 49/00; B29C 49/04; B29K 23/00; B29L 31/00; C08J 3/20; C08K 5/315

(52) U.S. Cl. CPC B41J 2/1754; B29B 9/10; B29B 9/12; B29B 17/0005; B29B 17/02; B29C 49/0005; B29C 49/04; C08J 3/203; C08K 5/315; B29B 2017/0015; B29B 2017/0279; B29B 2017/0282; B29K 2023/12; B29K 2995/0018; B29L 2031/712; C08J 2323/12

(57) ABSTRACT

A liquid storage container containing: a storage portion configured to store a liquid; a discharge portion configured to discharge the liquid; and a sealing portion configured to seal the discharge portion, wherein the liquid storage container contains a compound whose absorption spectrum peak changes when a pressure is applied to cause deformation, and the compound exhibits tribochromism.

### BACKGROUND OF THE INVENTION

### Field of the Invention

The present disclosure relates to a liquid storage container, a method for manufacturing a liquid storage container, and a method for reusing a liquid storage container.

### Description of the Related Art

In recent years, there has been a demand for the reuse of resources from the viewpoint of environmental consideration. For example, returnable bottles used for drinking water or the like are recovered by retailers or the like and then sent to recycling plants for a cleaning step and sterilization processing. After that, the returnable bottles are reused by drinking water manufacturers to fill their contents.

The cleaning step includes a step of inspecting containers such as bottles for defects such as cracks. Since cracks in bottles become visible when light is shone on them through refraction, they are relatively easy to visually inspect.

An average lifespan of returnable bottles is said to be approximately eight years after the bottles have been manufactured. Also, the bottles are recycled when defects are found during inspection.

In ink bottles for inkjet printers, there are also products in which genuine ink bottles are sold by non-genuine manufacturers while labeled as recycled products. It is expected that reuse of ink bottles will further increase in the future.

Japanese Patent Application Laid-open No. H06-122451 discloses a container containing a substance therein, whose container wall has a layer structure, and includes a layer that undergoes a color reaction with the stored substance or the outside air on an outer side of the innermost layer and on an inner side of the outermost layer.

### SUMMARY OF THE INVENTION

In the configuration of Japanese Patent Application Laid-open No. H06-122451, if a defect occurs in the outer layer of the container, a color of the container changes due to the color reaction with the outside air, making it possible to determine a defect.

The present inventors consider that, if environmental considerations continue to advance in the future, reuse of various containers may become mandatory. For example, in the inkjet market, it is also conceivable that resource saving measures will be required for liquid storage containers such as refillable ink bottles.

When liquid storage containers are reused, it is important to prevent deterioration of the quality and leakage of the stored liquid.

The present disclosure is directed to providing a liquid storage container that allows for simple defect inspection. Also, the present disclosure is directed to providing a method for manufacturing the liquid storage container. Further, the present disclosure is directed to providing a method for reusing the liquid storage container.

The present disclosure relates to a liquid storage container comprising:
a storage portion configured to store a liquid;
a discharge portion configured to discharge the liquid; and
a sealing portion configured to seal the discharge portion, wherein
the liquid storage container comprises a compound whose absorption spectrum peak changes when a pressure is applied to cause deformation, and
the compound exhibits tribochromism.

The present disclosure relates to a method for manufacturing the liquid storage container according to the present disclosure, comprising:
preparing a pellet comprising the compound and a resin; and
molding the pellet to obtain the liquid storage container.

The present disclosure relates to a method for reusing a liquid storage container comprising a storage portion configured to store a liquid, a discharge portion configured to discharge the liquid, and a sealing portion configured to seal the discharge portion,
wherein at least one selected from the group consisting of the storage portion, the discharge portion, and the sealing portion comprises a compound whose absorption spectrum peak changes when a pressure is applied to cause deformation,
the compound exhibits tribochromism, and
the method for reusing comprises:
cleaning the at least one selected from the group consisting of the storage portion, the discharge portion, and the sealing portion; and
sorting the at least one selected from the group consisting of the storage portion, the discharge portion, and the sealing portion obtained in the cleaning on the basis of the presence or absence of a change in the absorption spectrum peak.

According to the present disclosure, the liquid storage container that allows simple defect inspection is provided. Also, the present disclosure provides the method for manufacturing the liquid storage container. Further, the present disclosure provides the method for reusing the liquid storage container.

Further features of the present invention will become apparent from the following description of exemplary embodiments with reference to the attached drawings.

### BRIEF DESCRIPTION OF THE DRAWINGS

FIG. 1 is a perspective view of a liquid discharge device according to one embodiment;

FIG. 2 is a perspective view showing an internal configuration of the liquid discharge device according to one embodiment;

FIG. 3A is a perspective view of an ink bottle according to one embodiment;

FIG. 3B is a perspective view of the ink bottle according to one embodiment;

FIG. 4 is a schematic cross-sectional view of direct blow molding;

FIG. 5A is an explanatory diagram of direct blow molding;

FIG. 5B is an explanatory diagram of direct blow molding;

FIG. 5C is an explanatory diagram of direct blow molding;

FIG. 5D is an explanatory diagram of direct blow molding;

FIG. 6 is an explanatory diagram illustrating a change in structure of a molecule represented by formula (1);

FIG. 7A is an explanatory diagram of an ink bottle according to one embodiment;

FIG. 7B is an explanatory diagram of the ink bottle according to one embodiment;

FIG. 8A is an explanatory diagram illustrating a sealing portion;

FIG. 8B is an explanatory diagram illustrating the sealing portion;

FIG. 8C is an explanatory diagram illustrating the sealing portion;

FIG. 9A is an explanatory diagram of a slit valve type nozzle according to one embodiment;

FIG. 9B is an explanatory diagram of the slit valve type nozzle according to one embodiment;

FIG. 10 is an enlarged cross-sectional view of a nozzle and cap according to one embodiment;

FIG. 11A is a cross-sectional view showing a relationship between a slit valve and a protrusion according to one embodiment;

FIG. 11B is a cross-sectional view showing the relationship between the slit valve and the protrusion according to one embodiment;

FIG. 11C is a cross-sectional view showing the relationship between the slit valve and the protrusion according to one embodiment;

FIG. 11D is a cross-sectional view showing the relationship between the slit valve and the protrusion according to one embodiment;

FIG. 12A is a cross-sectional view of a nozzle according to one embodiment;

FIG. 12B is a cross-sectional view of the nozzle according to one embodiment; and

FIG. 13 is a perspective view of a liquid tank of a liquid discharge device according to one embodiment.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

Reference numerals in each figure are as follows.

001 Liquid discharge device, 002 Housing, 003 Liquid tank, 004 Liquid discharge head, 005 Carriage, 006 Carriage motor, 007 Liquid flow path, 008 Conveying roller, 009 Ink bottle, 010 Storage portion, 011 Nozzle, 012 Cap portion, 013 Identification region, 014 Pellet, 015 Screw, 016 Parison, 017 Mold, 018 Air blow pin, 019 Male screw, 020 Threaded portion, 021 Opening portion, 12 Liquid tank, 21 Storage portion, 22 Nozzle, 23 Cap, 24 Seal, 25 Valve, 26 Spring, 27 Holder

The present disclosure relates to a liquid storage container comprising:
a storage portion configured to store a liquid;
a discharge portion configured to discharge the liquid; and
a sealing portion configured to seal the discharge portion, wherein
the liquid storage container comprises a compound whose absorption spectrum peak changes when a pressure is applied to cause deformation, and
the compound exhibits tribochromism.

A liquid storage container of the present disclosure is, for example, a continuous ink supply system (CISS) bottle that contains inkjet ink. Also, in the present embodiment, an ink bottle is described as an example, but an object to be contained in the bottle is not limited to ink, and any liquid can be contained.

In addition, the liquid storage container can also be applied to a disposable head provided with a substrate for discharging ink, an ink tank of a type in which only the ink tank is replaced, and a bag-type ink bag for storing a large amount of ink.

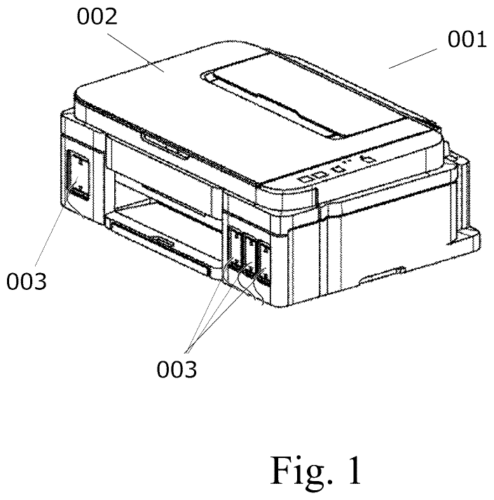

FIG. 1 is a perspective view of a liquid discharge device 001 according to the present embodiment.

The liquid discharge device is a serial type inkjet recording device, and has a housing 002 and a large-capacity liquid tank 003 disposed inside the housing 002.

The liquid tank 003 contains ink, which is a liquid to be discharged to a recording medium (not shown). That is, inkjet ink is preferably contained in the liquid storage container.

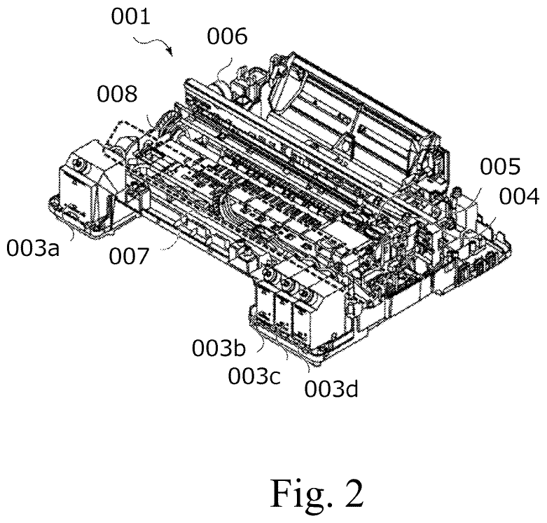

FIG. 2 is a perspective view showing an internal configuration of a main part of the liquid discharge device 001 shown in FIG. 1.

The liquid discharge device 001 includes a conveying roller 008 that conveys a recording medium (not shown), a carriage 005 provided with a liquid discharge head 004 that discharges a liquid, and a carriage motor 006 that drives the carriage 005.

Examples of the recording medium may include, for example, paper, but a type of the recording medium is not particularly limited as long as an image can be formed thereon by the liquid discharged from the liquid discharge head 004. The recording medium is intermittently conveyed by the conveying roller 008 being driven to rotate intermittently.

As the carriage motor 006 rotates, the carriage 005 reciprocates in directions intersecting a conveying direction of the recording medium. During the reciprocating scan, the liquid is discharged to the recording medium from a discharge port provided in the liquid discharge head 004, and thus an image or the like is recorded on the recording medium.

The liquid is stored in the liquid tank 003 and supplied to the liquid discharge head 004 through a liquid flow path 007.

In the present embodiment, for example, inks of cyan, magenta, yellow, and black are used as the liquid. In addition, four liquid tanks 003a to 003d, each of which stores a different color of ink, are provided as the liquid tank 003.

The four liquid tanks 003a to 003d are each disposed on a front surface portion of the liquid discharge device 001 inside the housing 002.

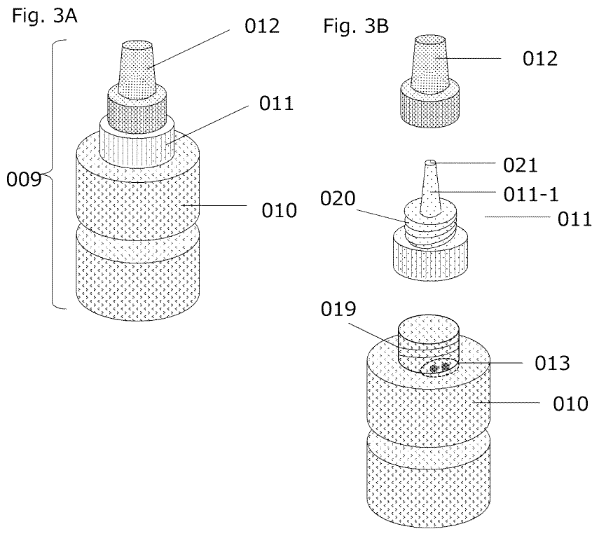

FIG. 3A is a perspective view of the ink bottle according to the present embodiment, and FIG. 3B is a perspective view showing the ink bottle in FIG. 3A in an unfolded state. The ink bottle 009 has a storage portion 010, a nozzle 011 for discharging ink serving as the liquid, and a cap portion 012.

A material of the liquid storage container is not particularly limited, and examples of the material include a polyethylene terephthalate resin, a polypropylene resin, a polyethylene resin, a polyvinyl chloride resin, and a polystyrene resin, for example. In the present embodiment, a liquid storage container made of polypropylene will be described.

In FIGS. 3A and 3B, the storage portion 010 has a cylindrical shape, but the shape of the storage portion is not particularly limited as long as it can contain the liquid such as ink, and may be, for example, a rectangular parallelepiped shape. Also, the storage portion is preferably hollow.

The nozzle 011 is a discharge portion that discharges the liquid and has an opening portion 021. That is, the discharge portion preferably has an opening portion. Through the opening portion, the liquid can be discharged from the storage portion. Also, in FIGS. 3A and 3B, the nozzle 011 has a hollow cone portion 011-1 and a hollow threaded portion 020, but the shape of the nozzle is not particularly limited.

The cap portion 012 is a sealing portion that seals the discharge portion. The cap portion 012 covers the opening portion 021 of the nozzle 011, and the nozzle 011 is covered with the cap portion 012 serving as a lid. That is, the sealing portion preferably covers at least a part of the discharge portion. If the discharge portion has an opening portion, it is more preferred that the sealing portion cover the opening portion of the discharge portion.

FIG. 3B shows a diagram in which the ink bottle in FIG. 3A is unfolded. For example, an outer surface of the storage portion 010 is preferably structured to screw into an inner surface of the nozzle 011. Also, an outer surface of a threaded portion 011-2 of the nozzle 011 is preferably structured to screw into an inner surface of the cap portion 012.

Specifically, a male screw 019 is formed on an outer surface of an upper portion of the storage portion 010. Also, a female screw (not shown) is formed on an inner surface of a lower portion of the nozzle 011. In addition, the female screw screws into the male screw 019 on the outer surface of the storage portion 010.

Further, the male screw serving as the threaded portion 020 is formed on an outer surface of the nozzle 011. Also, a female screw (not shown) is formed on an inner surface of a lower portion of the cap portion 012. The female screw screws into the male screw serving as the threaded portion 020 on the outer surface of the nozzle 011.

The ink bottle can inject the ink by gas-liquid exchange by removing the cap portion 012 and inserting the nozzle 011 into an ink injection port of a printer body.

Once all the ink has been injected into the body, the empty ink bottle is capped again and recovered. In some cases, it is also conceivable that an ink bottle with its cap removed, or with its nozzle also removed or the like is recovered, or is crushed and deformed in the process of recovery.

On the other hand, in recent years, a phenomenon of a substance's luminescence or change in absorption spectrum peak due to mechanical stimuli (for example, compression, stretching, shearing, bending, impact, and friction) or the like has been studied.

This is called mechanochromism, and mechanochromism has attracted attention as a phenomenon applicable to stress detection, risk prediction, and life prediction of materials toward the realization of a safe and secure society. However, many of the mechanochromisms are reversible characteristics and often return to the original absorption spectrum in several hours.

The liquid storage container contains a compound whose absorption spectrum peak changes when a pressure is applied to deform the container. Thus, when a pressure is applied to at least a part of the liquid storage container to deform the container, the absorption spectrum peak of the deformed portion changes. If there is a portion in which such a change occurs, it can be determined that a defect has occurred in the liquid storage container. This change can be confirmed by measuring the deformed portion of the liquid storage container using a spectrophotometer. In this way, by including the compound in the liquid storage container, a damaged or deformed liquid storage container predicted to occur in the process of recovery can be screened for through a simple inspection using the reusing method of the present disclosure, and the liquid storage container whose reliability has been confirmed can be reused at a low cost.

In particular, if a deformed ink bottle is reused, there is a risk of ink leakage and coloring of a member in contact with the ink. Accordingly, if the liquid storage container is an ink bottle, it is particularly important that the ink bottle contains a compound whose absorption spectrum peak changes when a pressure is applied to deform the ink bottle.

It is also preferable that the entire liquid storage container contain the compound. The compound will be described later.

Also, it is preferable that at least one selected from the group consisting of the storage portion, the discharge portion, and the sealing portion contain the compound.

It is assumed that, when liquid storage containers are recovered, they are expected to be recovered in a recovery box or the like. In the recovery box, it is assumed that foreign matters such as pieces of metal other than liquid storage containers will be mixed in, liquid storage containers having no discharge portion or sealing portion will be mixed in, liquid storage containers will be crushed, liquid storage containers will be damaged, and the like, and it is considered that defects are likely to occur in the liquid storage containers.

If the storage portion contains the compound, it is possible to confirm a defect occurring in the storage portion. If a defect has occurred in the storage portion, the liquid stored in the liquid storage container may leak from the storage portion. Even if the defect is not severe enough to cause the liquid to leak, when the defect spreads during distribution, at a retailer, or at a customer's location, the liquid may leak from the storage portion. Accordingly, it is preferable to be able to confirm the defect occurring in the storage portion.

Also, if the storage portion contains the compound and a pressure is applied to deform the compound, when the compound is a compound whose absorption spectrum peak in a visible region changes, it is preferable that the liquid storage container have a label portion that covers at least a part of the storage portion. Thus, even if a pressure is applied to at least a part of the storage portion to cause deformation and discoloration thereof, customers are less likely to misunderstand the liquid storage container as a defective one.

The storage portion preferably contains the resin described in the description of the liquid storage container.

If the discharge portion contains the compound, it is possible to confirm a defect occurring in the discharge portion. For example, if the liquid storage container is an ink bottle, the discharge portion may have various functions such as a function of preventing an error in color to be injected, or a function of preventing dripping of ink. Such a discharge portion can be said to be a component with a high added value. If a defect occurs in the discharge portion, the above functions may not be exhibited. Accordingly, it is preferable to be able to confirm the defect occurring in the discharge portion.

The discharge portion preferably contains the resin described in the description of the liquid storage container.

If the sealing portion contains the compound, it is possible to confirm a defect occurring in the sealing portion. The sealing portion seals the discharge portion in the liquid storage container, and prevents leakage of the liquid from the liquid storage container and evaporation of the liquid. Accordingly, if a defect occurs in the sealing portion, the liquid may leak from the liquid storage container or may evaporate. Accordingly, it is preferable to be able to confirm the defect occurring in the sealing portion.

The sealing portion preferably contains the resin described in the description of the liquid storage container.

The liquid storage container preferably has an identification region. The identification region contains a compound whose absorption spectrum peak changes when a pressure is applied to cause deformation. Thus, when a pressure is applied to deform the identification region, the absorption spectrum peak of the identification region changes.

A place at which the liquid storage container has the identification region is not particularly limited, but it is preferable that at least one selected from the group consisting of the storage portion, the discharge portion, and the sealing portion have the identification region. For example, at least a portion of at least one selected from the group consisting of a storage portion, a discharge portion, and a sealing portion may be used as an identification region. For example, it is preferable that the storage portion provide an identification region 013 at a root of the male screw 019 of the storage portion 010 in FIG. 3B.

Since the liquid storage container has the identification region, a marking portion can be provided by applying a pressure to perform marking each time the liquid storage container is reused. In addition, if the number of markings provided each time the liquid storage container is reused is set to, for example, one, the number of times of reuse of the liquid storage container can be known by counting the number of markings when the liquid storage container is recovered. By knowing the number of times of reuse of the liquid storage container, a liquid storage container that has reached a limit of the number of times of use can be recycled, and a liquid storage container that can still be used can be reused.

A method for applying a pressure to the identification region is not particularly limited as long as it does not damage the liquid storage container. For example, if an indenter with a tip diameter of 1 mm is pressed against a rod with an inner cylinder diameter of 30 mm at a pressure of 0.49 MPa to cause deformation to be recessed, the absorption spectrum peak of the identification region changes. Pressure conditions for marking can be determined by adjusting the inner cylinder diameter, the diameter of the indenter, and the pressure. For example, the inner cylinder diameter may be 25 to 50 mm. The diameter of the indenter may be 0.5 to 2.0 mm. Further, the pressure may be 0.3 to 0.6 MPa.

From the viewpoint of inhibiting breakage of the container, a thickness of the identification region is preferably large. Specifically, the thickness of the identification region is preferably 1.0 to 2.0 mm.

Among types of containers, for example, there are also containers of materials that are uneven in density between stretched and compressed portions, causing light to be diffusely reflected and appearing white, such as polystyrene containers. However, if the liquid storage container is colored, such as white, it may not be visible when the liquid storage container is deformed and turned white.

However, even if the liquid storage container is white as described above, the liquid storage container of the present disclosure allows simple defect inspection.

Also, if the compound whose absorption spectrum peak changes when a pressure is applied to cause deformation is a compound whose absorption spectrum peak in the visible region changes when a pressure is applied to cause deformation, and if the liquid storage container is white, discoloration of the deformed portion when the pressure is applied is more emphasized. Thus, a defective bottle can be easily screened visually.

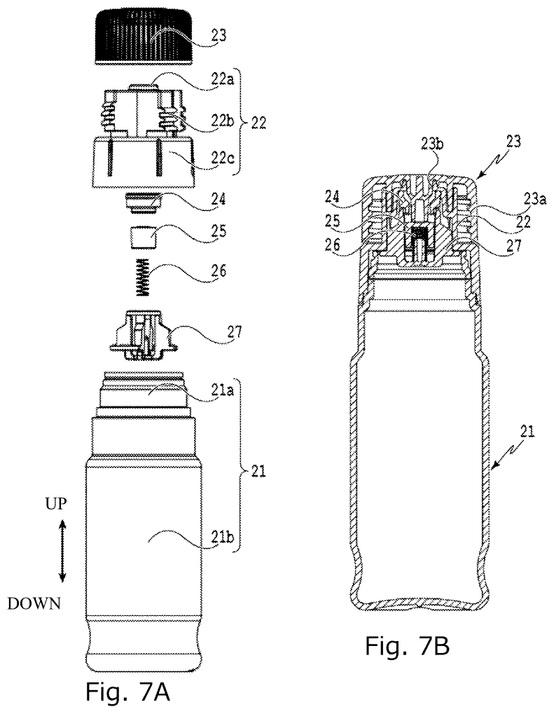

Also, a detailed configuration example of an ink bottle according to another embodiment is shown in FIGS. 7A and 7B. FIG. 7A is a diagram showing an example of a component configuration diagram of the ink bottle. FIG. 7B is a cross-sectional view showing the component configuration diagram of the ink bottle shown in FIG. 7A in an assembled state.

Inside a nozzle 22, a seal 24 having an opening, a valve 25 that opens and closes the opening of the seal 24, a spring 26 that biases the valve 25, and a holder 27 that fixes the spring 26 are provided.

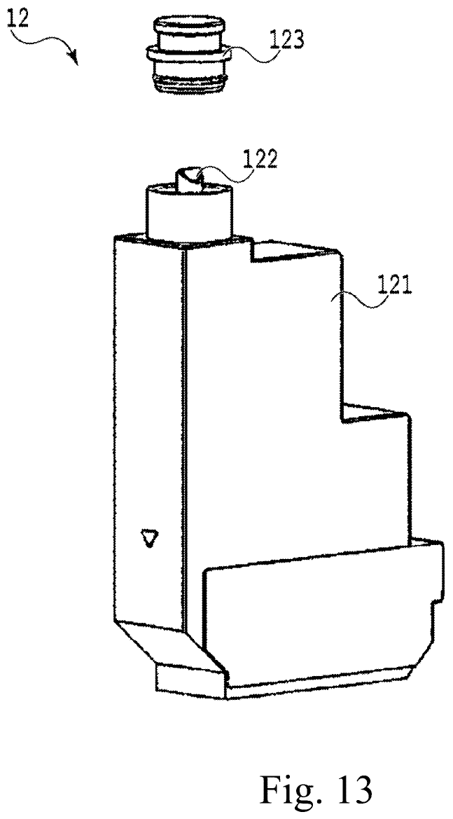

When ink is supplied from the ink bottle to the liquid tank 003, the nozzle 22 is inserted into an injection port of the liquid tank 003. FIG. 13 is a perspective view of a liquid tank 12 of a liquid discharge device according to one embodiment. Reference numeral 123 denotes a tank cover. The nozzle 22 is provided with a recessed portion that engages with a protruded portion provided on the liquid discharge device 001, and the ink bottle is positioned when an injection port 122 in FIG. 13 is inserted into the opening of the nozzle 22. Then, the ink in the ink bottle is stored in a tank body 121 via the injection port 122 due to a water head difference.

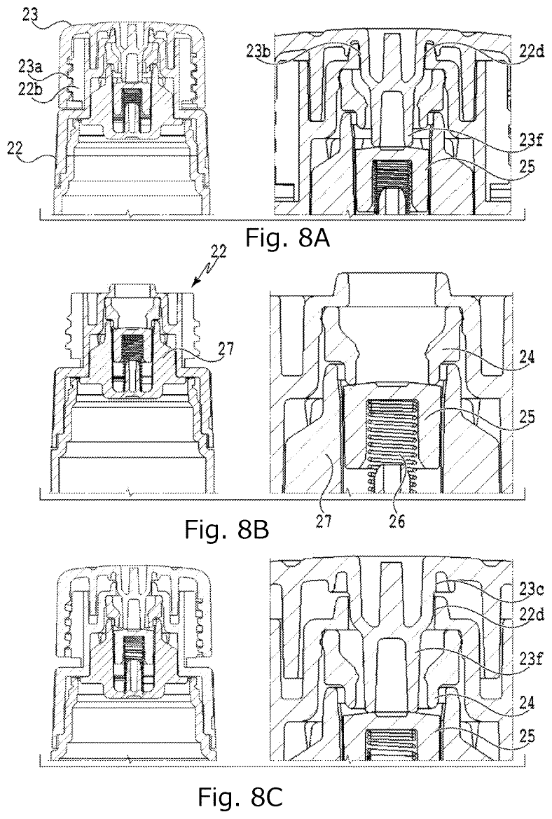

The ink bottle of the present embodiment has two sealable portions (hereinafter referred to as sealing portions). FIGS. 8A to 8C are explanatory diagrams illustrating the sealing portions, and as shown in FIG. 8A, a first sealing portion is sealed by fitting a cap 23 to the nozzle 22.

As shown in FIG. 8B, a second sealing portion is sealed by a valve structure in the nozzle 22. The sealing portions will be described below.

FIG. 8A is a cross-sectional view of an upper portion of the ink bottle with the cap 23 attached to the nozzle 22. The right side of FIG. 8A is an enlarged view of the cross-sectional view.

The first sealing portion is a place at which a cap sealing portion 23b of the cap 23 is fitted into a nozzle sealing portion 22d, which is part of an injection port 22a of the nozzle 22, by attaching the cap 23 to the nozzle 22.

As an example of a method for attaching the cap 23 to the nozzle 22, a method for screwing the nozzle 22 into the cap 23 can be exemplified. Specifically, as shown in FIGS. 7A and 7B and FIG. 8A, a method for screwing them together using a nozzle screw portion 22b having a male screw structure formed on an outer side of the nozzle 22 and a cap screw portion 23a having a female screw structure formed on an inner side of a lower portion of the cap 23 can be exemplified.

Also, on the contrary, the cap 23 having a male screw portion and the nozzle 22 having a female screw portion may be used.

In addition, as a method for attaching the cap 23 to the nozzle 22 other than screwing, a fitting portion other than the sealing portion may be provided. For example, the cap 23 may be fitted to an outer side of the nozzle 22. Further, the cap 23 may be an inner fitting lid that fits to an inner side of the nozzle 22.

FIG. 8B is a top cross-sectional view of the ink bottle with no cap 23 attached. The right side of FIG. 8B is an enlarged view of the cross-sectional view.

The second sealing portion is a place of a liquid stop valve structure (valve structure) disposed inside the nozzle 22 of the ink bottle. As shown in FIG. 8B, the seal 24, which is an orifice portion having an opening at its tip (upper end in FIG. 8B) into which the injection port 122 is inserted, is disposed on the nozzle 22.

Then, the valve 25, which is a valve body of the liquid stop valve, is biased toward the opening side by the spring 26 to close a gap between the seal 24 and the valve 25, and a bottle 21 is sealed.

In the present embodiment, the spring 26 is used as a biasing member, and the spring 26 is held by the holder 27 and fixed to an inner space of the nozzle 22. A material of the seal 24 is not particularly limited, but it is preferably made of a flexible member such as a rubber or elastomer.

With this liquid stop valve structure, the valve 25 is biased toward the opening of the seal 24 by the spring 26. For that reason, a sealed state inside the ink bottle can be maintained even when the cap 23 is removed from the nozzle 22.

When the ink is supplied to the liquid tank 003, the valve 25 is released by inserting the injection port 122 into the nozzle 22 through the opening of the seal 24. Then, as described above, the ink in the ink bottle is supplied to a storage chamber of the tank body 121 via the injection port 122 due to the water head difference.

In the present embodiment, when the cap 23 is open from the nozzle 22 and when the cap 23 is closed onto the nozzle, the first sealing portion and the second sealing portion are configured to temporarily open simultaneously.

Thus, the atmosphere is communicated with the inside of the bottle 21, and a pressure in the ink bottle can be made equal to an outside air pressure. Details will be described below.

First, when the cap 23 is in the closed state, the first sealing portion is in the sealed state as shown in FIG. 8A.

On the other hand, in the second sealing portion, a protrusion 23f disposed on the cap 23 is pressed in a direction opposite to a direction in which the valve 25 is biased with the closing of the cap 23. Thus, the gap is formed between the seal 24 and the valve 25.

In this way, in FIG. 8A, the second sealing portion is in the open state. That is, in the closed state of the cap 23, the first sealing portion is sealed and the second sealing portion is open. FIG. 8C is a cross-sectional view of the upper portion of the ink bottle when the cap 23 shown in FIG. 8A is moved from a state in which it is attached to the nozzle 22 to a state in which the cap 23 begins to open. The right side of FIG. 8C is an enlarged view of the cross-sectional view.

The cap 23 moves upward with the opening as shown in FIG. 8C from the closed state shown in FIG. 8A. With this movement of the cap 23, the cap sealing portion 23b and the nozzle sealing portion 22d are separated from each other, and the first sealing portion is open.

When the first sealing portion is open, the protrusion 23f disposed on the cap 23 is still at the position at which it presses the valve 25, as shown in FIG. 8C. That is, the second sealing portion maintains the open state. Accordingly, as shown in FIG. 8C, when the first sealing portion is open, the second sealing portion can also be open at the same time.

After that, when the cap 23 is further moved upward, the protrusion 23f is completely separated from the valve 25 with the movement of the cap 23, and the second sealing portion is sealed as shown in FIG. 8B.

When the cap 23 is closed from the open state, the protrusion 23f of the cap 23 also presses the valve 25 with the movement of the cap 23, and the second sealing portion is open. In this case, since the first sealing portion is in a state before sealing, the first sealing portion maintains the open state. After that, by bringing the cap 23 into the closed state, the first sealing portion is in the sealed state.

Also, the expression that the first sealing portion and the second sealing portion are open simultaneously means that they are open substantially at the same time. When the first sealing portion is open and the second sealing portion is open in conjunction with it, both are open simultaneously.

With the above-described configuration, when the cap 23 is open, the first sealing portion and the second sealing portion are temporarily in the open state at the same time, and thus the atmosphere is communicated with the inside of the bottle 21, and the pressure inside the bottle 21 can be equalized to the outside air pressure.

For this reason, when the cap 23 is open and the ink is refilled from the ink bottle into the tank body 121, dispersion of the ink due to an increase in an internal pressure of the ink bottle can be inhibited. In addition, overflow of the liquid from the tank body 121 can be inhibited.

Also, even when the cap 23 is open, the second sealing portion maintains the inside of the ink bottle in the sealed state, and thus leakage of the liquid can be inhibited even if the ink bottle is turned upside down.

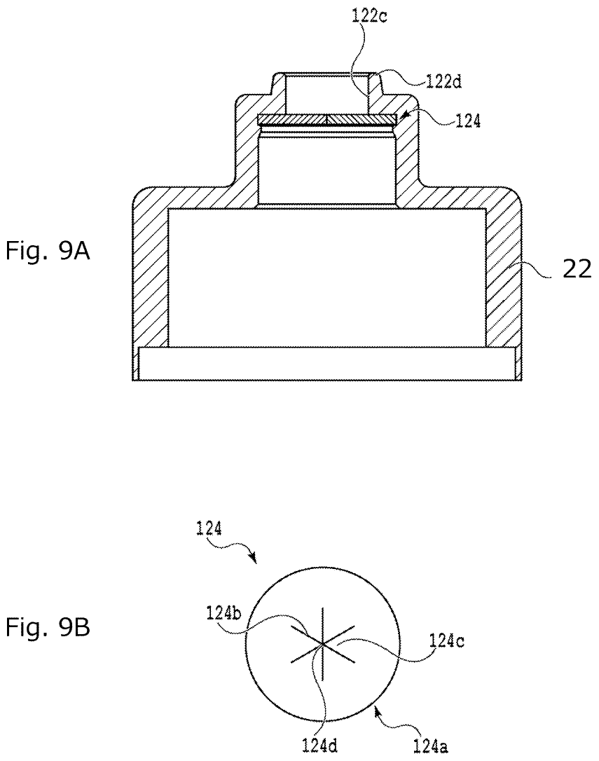

FIGS. 9A and 9B are explanatory diagrams of a slit valve type nozzle 22 according to another embodiment. FIG. 9A is a cross-sectional view of the nozzle 22, and FIG. 9B is a plan view of the slit valve.

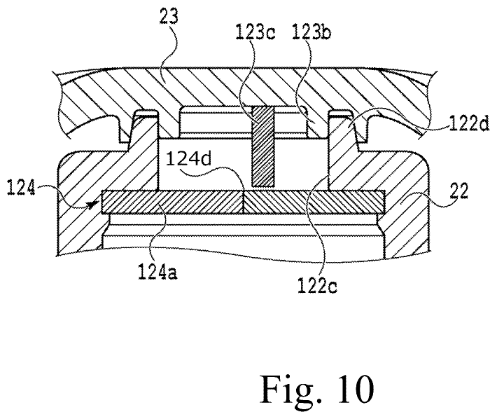

FIG. 10 is an enlarged cross-sectional view of the nozzle 22 and the cap 23 of the present embodiment. The nozzle 22 has an injection port 122c that injects the ink and a nozzle sealing portion 122d configured of an annular rib provided along its circumferential edge portion.

The injection port 122c is provided with a slit valve 124 that opens and closes depending on the internal pressure of the ink bottle. The slit valve 124 has a valve body 124a made of a flexible material and three slits 124b that are formed in the valve body 124a to intersect each other, and can seal the injection port 122c in its closed state. Six divided pieces 124c are formed on the valve body 124a by three slits 124b.

Also, the number of slits 124b is not limited to this, and may be two or four or more. In this case, the plurality of slits is preferably formed to be 2n-fold symmetrical with respect to a center of the valve body 124a. Thus, the divided pieces 124c can be open evenly, and the liquid in the ink bottle can be smoothly injected.

A cap sealing portion 123b configured of an annular rib and a protrusion 123c that protrudes toward the slit valve 124 are provided on a bottom surface (a surface facing the injection port 122c) of the cap 23. When the cap 23 is attached to the nozzle 22, the cap sealing portion 123b fits into the nozzle sealing portion 122d, and thus the injection port 122c is sealed together with the nozzle sealing portion 122d.

In a state in which the injection port 122c is sealed by the cap sealing portion 123b and the nozzle sealing portion 122d, a tip portion of the protrusion 123c faces the valve body 124a of the slit valve 124 at a position separated from an intersection point 124d of the plurality of slits 124b in a horizontal direction. The horizontal direction here corresponds to a radial direction of the nozzle 22.

With a configuration such as the protrusion 123c, as will be described later, the internal pressure of the bottle 21 can be released if the internal pressure is higher than the outside air pressure when the cap 23 is open. In the present embodiment, the protrusion 123c is provided integrally with the cap 23, but may be provided separately from the cap 23.

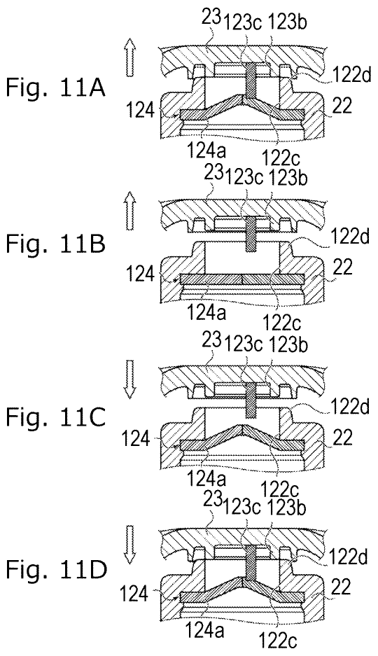

FIGS. 11A to 11D are cross-sectional views showing a relationship between the slit valve 124 and the protrusion 123c according to one embodiment. FIGS. 11A and 11B are cross-sectional views showing the relationship between the slit valve and the protrusion when the cap is open.

In a state in which the cap 23 is attached to the nozzle 22 and the injection port 122c is sealed, as described above, the protrusion 123c faces the valve body 124a at the position at which it is separated from the intersection point 124d of the slits 124b in the horizontal direction and does not contact the valve body 124a. Here, when the cap 23 begins to open, fitting of the cap sealing portion 123b to the nozzle sealing portion 122d is released, and the sealing of the injection port 122c is released.

In this case, if the internal pressure of the ink bottle is higher than the atmospheric pressure, the valve body 124a of the slit valve 124 is deformed to bulge outward due to the internal pressure of the bottle 21, as shown in FIG. 11A. Then, when the bulging valve body 124a comes into contact with the protrusion 123c, the slits 124b open to release the pressure in the bottle 21, and the bulge of the valve body 124a is eliminated.

After that, when the cap 23 is completely removed, the slits 124b close and the injection port 122c is sealed again, as shown in FIG. 11B.

When the ink is injected from the ink bottle into the liquid tank 12, a difference in the atmospheric pressure between the inside and the outside of the ink bottle is eliminated, and the injection port 122c is in the sealed state. For that reason, if the ink bottle is simply tilted, the pressure required for opening the slits 124b does not act on the slit valve 124, and leakage of the ink from the injection port 122c can be inhibited.

On the other hand, FIGS. 11C and 11D are cross-sectional views showing the relationship between the slit valve and the protrusion when the cap is closed.

When the internal pressure of the bottle 21 increases while the cap 23 is not attached to the nozzle 22, the valve body 124a of the slit valve 124 is deformed to bulge outward, as shown in FIG. 11C. Here, when the cap 23 begins to close, the protrusion 123c comes into contact with the bulging valve body 124a before the cap sealing portion 123b and the nozzle sealing portion 122d are fitted to each other, as shown in FIG. 11D. Thus, the slits 124b open to release the pressure in the bottle 21, and the bulge of the valve body 124a is eliminated. After that, the slits 124b are closed, and the injection port 122c is sealed.

In this case, since the bulge of the valve body 124a has been eliminated, the protrusion 123c faces the valve body 124a at the position at which it is separated from the intersection point 124d of the slits 124b in the horizontal direction and does not come into contact with the valve body 124a.

With this mechanism, even if the internal pressure of the ink bottle increases, the protrusion 123c is brought into contact with the slit valve 124 when the cap 23 is open or closed, and thus the internal pressure can be released to the outside.

A length of the protrusion 123c is not particularly limited, and can be set to an optimum length depending on an amount of deformation of the valve body 124a actually deformed due to an increase in the internal pressure of the bottle 21.

For example, if the amount of deformation of the valve body 124a is relatively small, in a state in which the injection port 122c is sealed by the cap sealing portion 123b and the nozzle sealing portion 122d, the tip portion of the protrusion 123c may come into contact with the valve body 124a to the extent that the valve body 124a is not deformed.

If the protrusion 123c is brought into contact with the bulging valve body 124a, in a state in which the cap 23 is attached to the nozzle 22 (the injection port 122c is sealed), the tip of the protrusion 123c may face the intersection point 124d of the slits 124b.

However, in this case, if the protrusion 123c is thin, the protrusion 123c may be inserted into the slits 124b near the intersection point 124d when the valve body 124a bulges, and the slits 124b may be maintained in the closed state. Accordingly, in this case, a thickness of the protrusion 123c is preferably such that the slits 124b can be open.

Also, even if the protrusion 123c is inserted as described above, the slits 124b may be maintained in the closed state. As a result, even if the protrusion 123c comes into contact with the bulging valve body 124a, the internal pressure of the bottle 21 may not be released.

From this perspective, the tip portion of the protrusion 123c preferably faces the valve body 124a of the slit valve 124 at the position at which it is separated from the intersection point 124d of the plurality of slits 124b in the horizontal direction with the injection port 122c sealed.

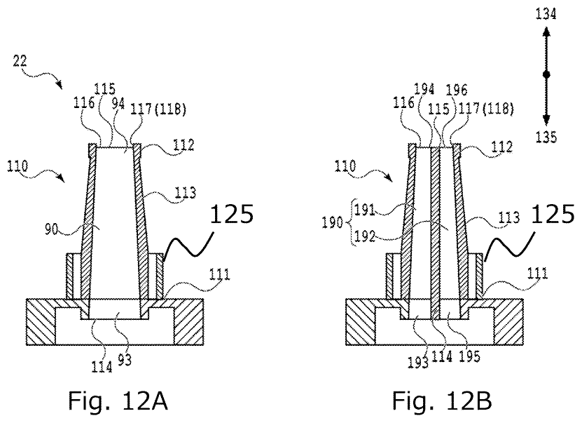

FIGS. 12A and 12B are diagrams illustrating a nozzle according to one embodiment. FIGS. 12A and 12B are cross-sectional views of the nozzle 22. In FIGS. 12A and 12B, the nozzle 22 has a cone portion 110 and a threaded portion 125.

As shown in FIG. 12A, the cone portion 110 protrudes in a first direction 134 from an outer surface of a bottom wall 111 of the nozzle 22. That is, even in a state in which the nozzle 22 is attached to the ink bottle, the cone portion 110 protrudes from the ink bottle in the first direction 134.

The cone portion 110 may protrude from the bottom wall 111 in the first direction 134 and may also protrude from the bottom wall 111 in a second direction 135. In addition, the cone portion 110 is provided to penetrate the bottom wall 111.

In FIGS. 12A and 12B, the cone portion 110 is substantially cylindrical and has an outer surface 112 whose cross-section has a circumferential surface shape.

An outer surface 113, which is a part of the outer surface 112, has a tapered shape and is inclined in a direction in which a diameter of its outer circumferential circle decreases from the bottom wall 111 in the first direction 134.

Such a shape allows the cone portion 110 to move smoothly when it is inserted into the tank starting from a distal end side away from the ink bottle.

Instead of the cone portion 110, a columnar portion having a cylindrical columnar shape or rectangular columnar shape may be used. For example, the shape may be such that the diameter of the outer circumferential circle is approximately the same from the bottom wall 111 to the tip and the outer surface extends in a vertical direction.

The cone portion 110 has a flow path 90 through which ink and gas flow. The flow path 90 penetrates the nozzle 22 in the first direction 134.

In FIGS. 12A and 12B, the flow path 90 extends in the first direction 134, but is not limited thereto and may be curved. Also, a cross-sectional shape of the flow path 90 may be circular or may be a shape other than circular.

In a state in which the nozzle 22 is attached to the storage portion of the ink bottle, one end of the flow path 90 communicates with the storage portion through an opening 93.

The other end of the flow path communicates with the outside of the nozzle 22 through an opening 94 on a nozzle distal end side away from the ink bottle. A shape of the opening 93 is not particularly limited, but may be, for example, circular. It is sufficient that the portion in which the opening 93 is formed is a base end portion of the cone portion 110 and is not limited to a base end surface 114.

The opening 94 is formed in a tip surface 115 forming an end portion of the cone portion 110 in the first direction 134. A shape of the opening 94 is not particularly limited, but may be, for example, circular.

FIG. 12B is a cross-sectional view of a nozzle having a two-hole configuration according to one embodiment. In FIG. 12B, the nozzle has a first flow path 191 and a second flow path 192.

The first flow path 191 and the second flow path 192 may have the same length or different lengths in a direction in which the ink flows, and cross-sectional shapes and cross-sectional areas of the first flow path 191 and the second flow path 192 may be the same or different.

The nozzle may have a flow path other than the first flow path 191 and the second flow path 192. That is, the nozzle may have a plurality of flow paths. The number of a plurality of flow paths 190 may be more than two. Lengths and shapes of respective flow paths of the plurality of flow paths 190 may be the same or different.

In FIG. 12B, a first A opening 193 and a first B opening 195 formed at the base end portion of the cone portion 110 are formed on the same plane. The first A opening 193 and the first B opening 195 may be formed on different surfaces. Also, a second A opening 194 and a second B opening 196 are formed on the tip surface 115 forming the end portion of the cone portion 110 in the first direction 134. It is sufficient that the portion in which the second A opening 194 and the second B opening 196 are formed is the tip portion of the cone portion 110, and is not limited to the tip surface 115.

In FIG. 12B, the first A opening 193, the first B opening 195, the second A opening 194, and the second B opening 196 are circular. However, the first A opening 193, the first B opening 195, the second A opening 194, and the second B opening 196 may be a shape other than circular.

In FIGS. 12A and 12B, the tip portion of the cone portion 110 is, for example, a portion of the cone portion 110 that is configured of the tip surface 115 and the outer surface 112. The cone portion 110 has a recessed portion 116 on the outer surface 112.

The recessed portion 116 is defined by the tip surface 115 and an inner surface 118 (one surface on a side) of an annular rib 117 protruding from an outer edge portion of the tip surface 115 in the first direction 134. That is, the tip surface 115 is recessed from the tip (tip of the annular rib 117) of the cone portion 110.

The inner surface 118 extends from the tip surface 115 toward an outer edge of the tip surface 115 while directing in the first direction 134. That is, the inner surface 118 extends in the first direction 134 while being inclined in a direction in which a diameter of the recessed portion 116 increases.

The inner surface 118 may extend in the first direction 134 without being inclined. Also, the cone portion 110 may not have the recessed portion 116. That is, the tip portion of the cone portion 110 may not be recessed.

The compound whose absorption spectrum peak changes when a pressure is applied to cause deformation will be described below.

For example, chromic molecules, whose molecular structure changes when exposed to an external pressure or stimuli, have a change in absorption spectrum.

The present inventors have considered to use a resin material, to which a polymer obtained by polymerizing chromic molecules is added, for molding a liquid storage container.

Examples of the chromic molecules include the molecule represented by the following formula (1) (3-dicyclopropylmethylene-5-dicyanomethylene-4-diphenylmethylenetetrahydrofuran-2-one).

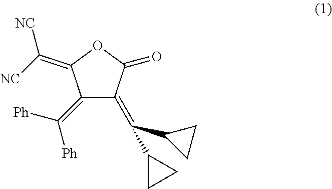

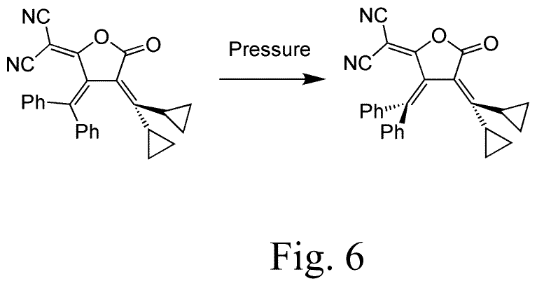

A polymer obtained by polymerizing the molecule represented by the above formula (1) is a polymer whose color changes from yellow to red when a steric structure of its diphenylmethylene portion is distorted by applying a pressure thereto, which has been revealed in X-ray structural analysis. FIG. 6 shows a state in which a structure of the molecule represented by the above formula (1) changes by applying a pressure thereto. The molecule represented by formula (1) is yellow, and the molecule resulted after the pressure has been applied is red. It is conceivable that, also in the polymer obtained by polymerizing the molecule represented by the formula (1), the structure derived from the molecule represented by the formula (1) in the polymer changes in the same way to change color.

Examples of the chromic molecules include molecules that exhibit piezochromism and molecules that exhibit tribochromism as properties of changing an absorption spectrum peak in response to mechanical stimulation, for example. In the present disclosure, irreversible tribochromism is considered appropriate to identify defects in the liquid storage container. That is, the compound whose absorption spectrum peak changes when a pressure is applied to cause deformation exhibits tribochromism. In the present disclosure, tribochromism indicates irreversible one of properties that change the absorption spectrum peak in response to mechanical stimulation. Here, irreversible means that the absorption spectrum peak does not return to the original peak even if left alone after the absorption spectrum peak has changed in response to mechanical stimulation.

Examples of the molecules that exhibit tribochromism include at least one selected from the group consisting of the molecule represented by the above formula (1), fluorenylidene acridan, tetraphenylpyrene, and derivatives thereof, and at least one compound selected from the group consisting of fluorenylidene acridan and tetraphenylpyrene is preferable.

Also, the compound whose absorption spectrum peak changes when a pressure is applied to cause deformation is preferably a polymer of a chromic molecule. Here, the compound may be a polymer of a chromic molecule and a molecule other than the chromic molecule. For example, the compound can be obtained by introducing a reactive functional group such as a vinyl group into a chromic molecule and copolymerizing the chromic molecule with a monomer that reacts with the reactive functional group.

The present disclosure is not limited thereto, and other materials whose absorption wavelengths change when a pressure is applied can also be used.

A content of the compound whose absorption spectrum peak changes when a pressure is applied to cause deformation in the liquid storage container is not particularly limited, but may be 0.1 to 10 mass %. Also, if the storage portion contains the compound, the content of the compound in the storage portion is not particularly limited, but may be 0.1 to 10 mass %. Also, if the discharge portion contains the compound, the content of the compound in the discharge portion is not particularly limited, but may be 0.1 to 10 mass %. Also, if the sealing portion contains the compound, the content of the compound in the sealing portion is not particularly limited, but may be 0.1 to 10 mass %.

For the compound whose absorption spectrum peak changes when a pressure is applied to cause deformation, a position of its peak top may change, or an intensity of the peak top may change, but it is preferable that the position of the peak top change.

It is preferable that the position of the peak top of the absorption spectrum change by 250 to 400 nm when a pressure is applied to the compound. This makes it easier to identify defects in the liquid storage container.

Also, it is preferable that the compound whose absorption spectrum peak changes when a pressure is applied to cause deformation be a compound whose absorption spectrum peak in the visible region changes when a pressure is applied to cause deformation. When the absorption spectrum peak in the visible region changes, the color when observed changes. For that reason, defects in the liquid storage container can be identified visually. Thus, the defect inspection can be performed more simply.

Further, it is more preferable that the position of the peak top of the absorption spectrum of the compound change by 250 to 400 nm within a range of the visible region when a pressure is applied to the compound. Thus, it becomes easier to visually identify defects in the liquid storage container.

The manner in which the liquid storage container contains the compound is not particularly limited. When the liquid storage container contains a resin, the resin preferably contains the compound. In the case of the configuration of Japanese Patent Application Laid-open No. H06-122451, the present inventors have found that the reagent that changes the color of the container may leak out, but unlike the configuration of Japanese Patent Application Laid-open No. H06-122451, if the resin contains the compound, the compound is less likely to leak.

Similarly, if at least one selected from the group consisting of the storage portion, the discharge portion, and the sealing portion contains a resin, the resin preferably contains the compound.

In the above-described respective configuration examples, the example in which the liquid discharge device using the ink bottle serving as the liquid storage container is a serial type liquid discharge device that discharges the liquid from the liquid discharge head in accordance with the reciprocating movement of the carriage has been described.

However, the present disclosure is not limited to this example, and the liquid storage container may be used in a so-called full-line type liquid discharge device including a liquid discharge head having discharge ports formed across a width of the recording medium.

A method for reusing a liquid storage container will be described below.

The method for reusing a liquid storage container is
a method for reusing a liquid storage container including a storage portion that stores a liquid, a discharge portion that discharges the liquid, and a sealing portion that seals the discharge portion,
wherein at least one selected from the group consisting of the storage portion, the discharge portion, and the sealing portion contains a compound whose absorption spectrum peak changes when a pressure is applied to cause deformation,
the compound exhibits tribochromism, and
the method for reusing includes
a cleaning step of cleaning the at least one selected from the group consisting of the storage portion, the discharge portion, and the sealing portion, and
a sorting step of sorting the at least one selected from the group consisting of the storage portion, the discharge portion, and the sealing portion obtained in the cleaning step on the basis of the presence or absence of a change in the absorption spectrum peak.

The method for reusing a liquid storage container includes the cleaning step of cleaning the at least one selected from the group consisting of the storage portion, the discharge portion, and the sealing portion. That is, in the method for reusing the liquid storage container, a part of the members forming the liquid storage container may be reused, or the entire liquid storage container may be reused. Hereinafter, a part of the members forming the liquid storage container and the entire liquid storage container will be referred to as the liquid storage container or the like. In the cleaning step, the cleaned liquid storage container or the like is in a reusable state. A known process can be used for the cleaning step.

Here, the at least one selected from the group consisting of the storage portion, the discharge portion, and the sealing portion is cleaned. Among others, it is preferable to clean highly functional members. For example, by reusing a functional portion such as the discharge portion, which is expensive to manufacture, it is possible to provide a customer with an inexpensive ink bottle in addition to resource saving.

The method for reusing a liquid storage container includes the sorting step of sorting the at least one selected from the group consisting of the storage portion, the discharge portion, and the sealing portion obtained in the cleaning step on the basis of the presence or absence of a change in the absorption spectrum peak. As described above, since the liquid storage container contains the compound whose absorption spectrum peak changes when a pressure is applied to cause deformation, the sorting step can be performed simply. By performing the sorting step, the liquid storage container or the like with few defects can be reused.

For example, if the liquid storage container or the like does not have the above-described identification region, the liquid storage container or the like in which a change in the absorption spectrum peak is not confirmed and the liquid storage container or the like in which a change in the absorption spectrum peak is confirmed are sorted. Thus, the liquid storage container or the like with few defects can be reused.

Further, when the liquid storage container or the like has the above-described identification region, a change in the absorption spectrum peak is confirmed for portions other than the identification region, and the liquid storage container or the like in which the change in the absorption spectrum peak is not confirmed and the liquid storage container or the like in which the change in the absorption spectrum peak is confirmed are sorted. The marking portion in the identification region may be a marking portion provided by the method for reusing according to the present disclosure. On the other hand, the marking portion in portions other than the identification region may be a defect in the liquid storage container.

Also, when the compound whose absorption spectrum peak changes when a pressure is applied to cause deformation is the compound whose absorption spectrum peak in the visible region changes when a pressure is applied to cause deformation, the sorting step can be a step of sorting the at least one selected from the group consisting of the storage portion, the discharge portion, and the sealing portion obtained in the cleaning step on the basis of the presence or absence of discoloration.

For example, when the liquid storage container or the like does not have the above-described identification region, the liquid storage container or the like whose discoloration is not visually confirmed and the liquid storage container or the like whose discoloration is visually confirmed are sorted. Thus, the liquid storage container or the like with no visible discoloration and few defects can be reused.

Further, when the liquid storage container or the like has the above-described identification region, discoloration is visually confirmed in the portions other than the identification region, and the liquid storage container or the like whose discoloration is not visually confirmed and the liquid storage container or the like whose discoloration is visually confirmed are sorted. The marking portion in the identification region may be a marking portion provided by the method for reusing according to the present disclosure. On the other hand, the marking portion in the portions other than the identification region may be a defect in the liquid storage container.

The method for reusing a liquid storage container may include a recovery step of recovering the liquid storage container. A known process can be used for the recovery step. For example, the method for reusing a liquid storage container may include a step of collecting the liquid storage containers in the recovery box and recovering the collected liquid storage containers.

Also, the method for reusing a liquid storage container preferably includes a marking step of applying a pressure to at least a part of the liquid storage container to deform the liquid storage container and changing the absorption spectrum peak of the compound to provide the marking portion.

By including the marking step, the absorption spectrum of at least a part of the reused liquid storage container changes. Thus, it becomes possible to know that the liquid storage container has been reused.

A method for applying a pressure to at least a part of the liquid storage container is not particularly limited unless the liquid storage container is damaged. For example, a method for applying a pressure to the above-mentioned identification region can be used.

A place in which a pressure is applied to the liquid storage container to cause deformation is not particularly limited. For example, it may be at least a part of the at least one selected from the group consisting of the storage portion, the discharge portion, and the sealing portion, and is preferably the above-mentioned identification region.

Also, it is preferable that only one marking portion be formed in the marking step, and that the marking step be performed once each time the liquid storage container is reused. When the liquid storage container is recovered, the number of times of reuse of the liquid storage container can be known by counting the number of marking portions formed in the marking step. By knowing the number of times of reuse of the liquid storage container, the liquid storage container that has reached the limit of the number of times of use can be recycled, and the usable liquid storage container can be reused.

That is, the method for reusing a liquid storage container preferably includes a step of reading the number of marking portions formed in the marking step.

An example of a method for manufacturing a liquid storage container will be described below.

The method for manufacturing a liquid storage container is a method for manufacturing the liquid storage container according to the present disclosure, the method including
a step of preparing a pellet containing the compound and a resin; and
a molding step of molding the pellet to obtain the liquid storage container.

For example, the step of preparing the pellet may be a step of manufacturing the pellet. An example of the method for manufacturing the pellet will be shown. For example, the compound whose absorption spectrum peak changes when a pressure is applied to cause deformation, and a resin are melted and kneaded to form the pellet.

The resin is not particularly limited, and examples thereof include resins such as a polyethylene terephthalate resin, a polypropylene resin, a polyethylene resin, a polyvinyl chloride resin, and a polystyrene resin, and the polypropylene resin is preferred.

A known means can be used for the molding step. The molding step of the liquid storage container is not particularly limited, and examples thereof include injection molding, compression molding, vacuum molding, blow molding, and the like. Specifically, the molding is performed by injecting heated and melted plastic into a mold at a high pressure. Among others, injection molding or blow molding is preferred, and blow molding is more preferred.

### EXAMPLES

Examples of the present disclosure will be described below with reference to schematic diagrams. The present disclosure is not limited to these examples.

### Comparative Example 1

It was assumed that the storage portion 010 was recovered, and in the case of the storage portion made of polypropylene, a deformation state was observed when a stress of about 500 N, which is a force of a person's foot stepping on the storage portion, was applied.

When an ink bottle made of polypropylene was crushed by stepping on it with a foot, it naturally returned to its original shape due to elastic deformation. However, it was partially bent and hardened, and it was difficult to determine whether to be deformed or not depending on an angle at which the shape was visually observed. That is, the defect inspection could not be simply performed.

### Example 1

An ink bottle according to Example 1 is manufactured by direct blow molding as follows.

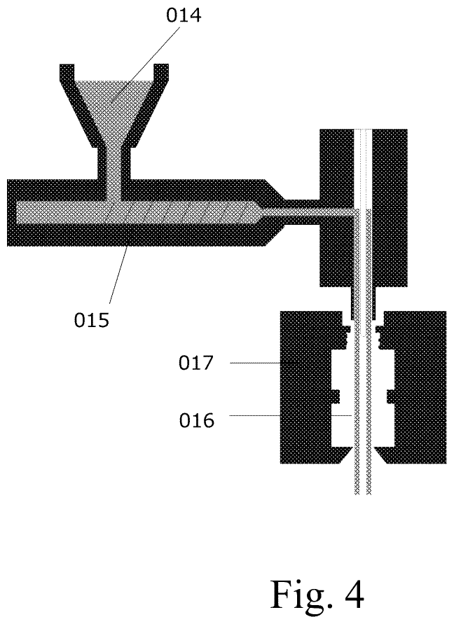

First, a polymer obtained by polymerizing the molecule represented by the above formula (1) and polypropylene are melted and kneaded to obtain a pellet. Then, the obtained pellet 014 is heated and melted as shown in FIG. 4, and a parison 016, which is a cylindrical molten plastic, is extruded by a screw 015. In FIG. 4, reference numeral 017 denotes a mold.

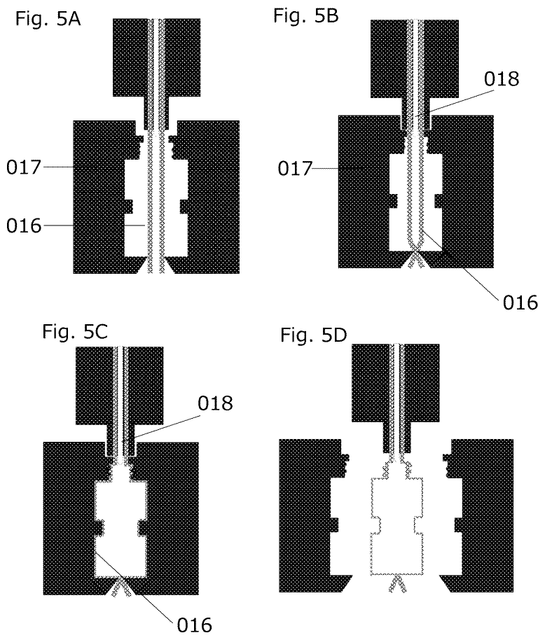

FIG. 5A is a schematic diagram of a mold portion illustrating direct blow molding, which is one example of the manufacturing method. FIG. 5A shows a state in which the parison 016 is stretched cylindrically inside the mold.

As shown in FIG. 5B, the mold 017 is closed to sandwich the parison 016 from both sides. After that, as shown in FIG. 5C, compressed air is blown in from an air blow pin 018, and the parison 016 is pressed against an inner wall of the mold by a pressure of the air. In that state, the parison 016 is cooled and solidified.

After that, as shown in FIG. 5D, the mold is opened to take out the molded article, and unnecessary burrs are cut off to mold the storage portion of the ink bottle.

In this case, the parison spreads less in the mold at a portion of a mouth of the storage portion. For that reason, the portion of the mouth is molded to be thicker. This portion is made into the identification region showing the number of times of reuse. That is, the identification region is provided at a root of the mouth of the storage portion 010. Thus, deterioration of the quality of the container due to the marking can be inhibited.

The recovered ink bottle is first cleaned of dirt from the inside and outside. After that, the ink bottle whose defective color was visually confirmed is recycled without being reused. Also, marks in the identification region 013 are counted, and the bottle that has reached the limit of the number of times of reuse is recycled without being reused.

Further, by providing a product label film (not shown) in the identification region, even if at least a part of the identification region is discolored, the customer is less likely to mistake the ink bottle for a defective product.

As described above, since the ink bottle contains the compound whose absorption spectrum peak changes when a pressure is applied to cause deformation, the defect inspection can be simply performed. That is, the ink bottle with fewer defects can be reused, which can contribute to resource saving.

### Example 2

There are various methods for injecting ink from an ink bottle into a liquid tank. Nozzle components may also be provided with a variety of functions. For example, such a nozzle that may have various functions including a function of preventing a wrong color from being injected, a function of preventing dripping of ink, and the like can be said to be a component with a high added value.

If a defect occurs in the nozzle with such functions during recovery for reuse, the above functions may no longer be exhibited. Accordingly, it has been contemplated to use the compound whose absorption spectrum peak changes when a pressure is applied to cause deformation for molding important functional components.

In the present Example, the molding of the nozzle is performed using injection molding (not shown). The pellet described in Example 1 is placed in a heating cylinder of an injection molding machine and melted by heating, and the melted pellet is then injected into the mold using an extrusion screw.

After that, polypropylene in the mold is cooled until it solidifies. After that, the mold is opened to take out the molded nozzle.

Thus, even if a pressure is applied to the nozzle, which is thin and vulnerable to a pressure from the outside, in the process of recovery and a defect occurs, the defect inspection can be simply performed by visual inspection before reuse.

### Example 3

There are ink bottles of a type that is used by first opening a mouth of a storage portion and attaching a nozzle thereto, a type that is sealed with only a cap, and the like.

In these ink bottles, not all the ink is injected into a main body in one use, but some of the ink is injected, and then the remainder is stored by covering the cap. For that reason, if the cap is not tightly sealed, components of the ink may evaporate, which affects printing performance.

In addition, since the cap prevents leakage of the ink from an opened ink bottle, it is desirable to be able to prevent leakage of the ink regardless of the posture when stored.

As described above, the cap is a component that prevents evaporation of the ink and also prevents leakage of the ink. For that reason, quality inspection of the recovered cap is important. Accordingly, it has been contemplated to use the compound whose absorption spectrum peak changes when a pressure is applied to cause deformation for molding the cap.

In an ink bottle having such a structure that the cap protrudes, it is also conceivable that the cap is easily deformed when it is mixed with a large number of containers or foreign matters. Accordingly, by using the compound whose absorption spectrum peak changes, defects can be more easily found.

In the present Example, the molding of the cap is performed using injection molding (not shown). The pellet described in Example 1 is placed in a heating cylinder of an injection molding machine and melted by heating, and the melted pellet is injected into a mold by an extrusion screw.

After that, polypropylene in the mold is cooled until it solidifies. After that, the mold is opened, and the molded cap is removed.

Thus, the defect inspection can be simply performed by visual inspection before reuse. As a result, evaporation and deterioration of components of the ink due to poor sealing and leakage of the ink when the ink bottle is stored in a laid-down posture are prevented.

In this way, if the damaged and deformed ink bottle generated in the process of recovery could be screened through a simple inspection in a process for reuse, it is possible to curb investment costs for expensive inspection equipment, and to reuse the ink bottle whose reliability has been confirmed.

As described above, the present disclosure provides the liquid storage container that allows simple defect inspection. That is, it is possible to reuse the liquid storage container with fewer defects, which can contribute to resource saving.

The technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-077935, filed May 13, 2024, which is hereby incorporated by reference herein in its entirety.

What is claimed is:

1. A liquid storage container comprising:
a storage portion configured to store a liquid;
a discharge portion configured to discharge the liquid; and
a sealing portion configured to seal the discharge portion, wherein
the liquid storage container comprises a compound whose absorption spectrum peak changes when a pressure is applied to cause deformation, and
the compound exhibits tribochromism.

2. The liquid storage container according to claim 1, wherein
the discharge portion is a discharge portion configured to discharge the liquid from the storage portion,
the sealing portion covers at least a part of the discharge portion, and
at least one selected from the group consisting of the storage portion, the discharge portion, and the sealing portion comprises the compound.

3. The liquid storage container according to claim 1, wherein a position of a peak top of the absorption spectrum of the compound changes by 250 to 400 nm when a pressure is applied to the compound.

4. The liquid storage container according to claim 3, wherein the position of the peak top of the absorption spectrum of the compound changes by 250 to 400 nm within a range of a visible region when a pressure is applied to the compound.

5. The liquid storage container according to claim 1, wherein the compound is at least one compound selected from the group consisting of fluorenylidene acridan and tetraphenylpyrene.

6. The liquid storage container according to claim 1, wherein the storage portion comprises the compound.

7. The liquid storage container according to claim 1, wherein the storage portion comprises a resin and the compound.

8. The liquid storage container according to claim 6, wherein the liquid storage container comprises a label portion configured to cover at least a part of the storage portion, and the label portion displays properties of the liquid.

9. The liquid storage container according to claim 1, wherein
the discharge portion comprises a nozzle configured to discharge the liquid, and
the nozzle comprises the compound.

10. The liquid storage container according to claim 1, wherein the discharge portion comprises a resin and the compound.

11. The liquid storage container according to claim 1, wherein the sealing portion comprises the compound.

12. The liquid storage container according to claim 1, wherein the sealing portion comprises a resin and the compound.

13. The liquid storage container according to claim 1, wherein
the liquid storage container comprises a resin, and
the resin comprises the compound.

14. The liquid storage container according to claim 1, wherein an inkjet ink is stored in the liquid storage container.

15. A method for manufacturing the liquid storage container according to claim 1, comprising:
preparing a pellet comprising the compound and a resin; and
molding the pellet to obtain the liquid storage container.

16. A method for reusing a liquid storage container comprising a storage portion configured to store a liquid, a discharge portion configured to discharge the liquid, and a sealing portion configured to seal the discharge portion,
wherein at least one selected from the group consisting of the storage portion, the discharge portion, and the sealing portion comprises a compound whose absorption spectrum peak changes when a pressure is applied to cause deformation,
the compound exhibits tribochromism, and
the method for reusing comprises:
cleaning the at least one selected from the group consisting of the storage portion, the discharge portion, and the sealing portion; and
sorting the at least one selected from the group consisting of the storage portion, the discharge portion, and the sealing portion obtained in the cleaning on the basis of the presence or absence of a change in the absorption spectrum peak.

17. The method for reusing a liquid storage container according to claim 16, wherein
the liquid storage container comprises a resin, and
the resin comprises the compound.

18. The method for reusing a liquid storage container according to claim 16, further comprising providing a marking portion by applying a pressure to at least a part of the liquid storage container to deform the liquid storage container and changing an absorption spectrum peak of the compound.

19. The method for reusing a liquid storage container according to claim 18, further comprising reading the number of the marking portions formed in the providing the marking portion.
